(19) United States
(12) Patent Application Publication
(10) Pub. No.: US 2020/0283022 A1
(43) Pub. Date: Sep. 10, 2020

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventors: Yuki Hara, Wako-shi (JP); Yasushi Shoda, Wako-shi (JP); Junpei Noguchi, Wako-shi (JP); Ryoma Taguchi, Tokyo (JP); Yuta Takada, Tokyo (JP)

(21) Appl. No.: 16/795,637

(22) Filed: Feb. 20, 2020

(30) Foreign Application Priority Data
Mar. 7, 2019 (JP) 2019-041878

(51) Int. Cl. B60W 60/00; G06K 9/00

(52) U.S. Cl. CPC B60W 60/0023; B60W 60/0024; G06K 9/00791; B60W 60/0016; B60W 60/005; B60W 60/0025

(57) ABSTRACT

According to an embodiment, there is provided a vehicle control system including a recognizer configured to recognize a surrounding environment of a vehicle, a driving controller configured to perform driving control based on one or both of speed control and steering control of the vehicle on the basis of a recognition result of the recognizer, an acquirer configured to acquire the remaining amount of energy of a terminal device of an occupant of the vehicle or the remaining amount of energy of the vehicle, and a notification controller configured to provide a notification to the occupant when traveling based on the driving control is predicted to be started by the driving controller and when the remaining amount of energy acquired by the acquirer is less than or equal to a threshold value.

### CROSS-REFERENCE TO RELATED APPLICATION

Priority is claimed on Japanese Patent Application No. 2019-041878, filed Mar. 7, 2019, the content of which is incorporated herein by reference.

### BACKGROUND

### Field of the Invention

The present invention relates to a vehicle control system, a vehicle control method, and a storage medium.

### Description of Related Art

In recent years, research has been conducted on automatically controlling vehicles. In connection with this, technology for calculating a period of time required for a vehicle to arrive at a place when a user gets into the vehicle and presenting an arrival time to the user's portable terminal on the basis of the calculated period of time is known (for example, Japanese Unexamined Patent Application, First Publication No. 2015-176468). Also, conventionally, technology for limiting a specific operation on a vehicle according to a value indicating the remaining amount of battery power of a portable unit when the user performs a vehicle operation from the portable unit is known (for example, Japanese Unexamined Patent Application, First Publication No. 2006-225975).

### SUMMARY

However, in the conventional technology, when the remaining amount of battery power of a terminal device of a user is used up, communication with a vehicle is disabled and an instruction cannot be issued from the terminal device to the vehicle or the terminal device cannot acquire information from the vehicle. In some cases, communication with the terminal device may not be performed also when there is no fuel in the vehicle.

Aspects of the present invention have been made in consideration of such circumstances and an objective of the present invention is to provide a vehicle control system, a vehicle control method, and a storage medium capable of minimizing situations in which communication with a vehicle is disabled.

A vehicle control system, a vehicle control method, and a storage medium according to aspects of the present invention adopt the following configurations.

(1): According to an aspect of the present invention there is provided a vehicle control system including: a recognizer configured to recognize a surrounding environment of a vehicle; a driving controller configured to perform driving control based on one or both of speed control and steering control of the vehicle on the basis of a recognition result of the recognizer; an acquirer configured to acquire the remaining amount of energy of a terminal device of an occupant of the vehicle or the remaining amount of energy of the vehicle; and a notification controller configured to provide a notification to the occupant before a point where traveling based on the driving control is predicted to be started when the traveling based on the driving control is predicted to be started by the driving controller and when the remaining amount of energy acquired by the acquirer is less than or equal to a threshold value.

(2): In the above-described aspect (1), the notification controller provides the notification to the occupant before a point where the traveling based on the driving control is predicted to be started by the driving controller when the traveling based on the driving control is predicted to be started by the driving controller and when the remaining amount of energy is less than or equal to the threshold value.

(3): In the above-described aspect (1), the recognizer recognizes a first parking area where traveling based on the driving control and traveling based on manual driving of the occupant of the vehicle are possible and a second parking area where traveling based on the driving control is possible, and the notification controller provides a notification of the remaining amount of energy to the occupant before the vehicle arrives at the first parking area and the second parking area recognized by the recognizer.

(4): In the above-described aspect (1), the notification controller notifies the occupant of information for inquiring about whether or not to execute traveling based on the driving control before a point where the traveling based on the driving control is predicted to be started.

(5): In the above-described aspect (1), the vehicle control system further includes a storage battery configured to supply electric power for travel driving of the vehicle, wherein the acquirer acquires the remaining amount of energy of the storage battery, and wherein the notification controller provides the notification to the occupant when the traveling based on the driving control is predicted to be started by the driving controller and when the remaining amount of energy of the storage battery acquired by the acquirer is less than or equal to the threshold value.

(6): In the above-described aspect (5), the notification controller notifies the occupant of information for inquiring of the occupant about whether or not to charge the storage battery when the remaining amount of energy of the storage battery is less than or equal to the threshold value.

(7): In the above-described aspect (6), the notification controller notifies the occupant of a charging time period of the storage battery when an instruction for charging the storage battery has been received from the occupant.

(8): In the above-described aspect (7), the notification controller notifies the occupant of the remaining amount of energy of the storage battery estimated to be charged until a return time when the return time for the vehicle of the occupant has been received.

(9): According to an aspect of the present invention, there is provided a vehicle control method including: recognizing, by a computer, a surrounding environment of a vehicle; performing, by the computer, driving control based on one or both of speed control and steering control of the vehicle on the basis of a recognition result; acquiring, by the computer, the remaining amount of energy of a terminal device of an occupant of the vehicle or the remaining amount of energy of the vehicle; and providing, by the computer, a notification to the occupant when traveling based on the driving control of the vehicle is predicted to be started and when the remaining amount of energy that has been acquired is less than or equal to a threshold value.

(10): According to an aspect of the present invention, there is provided a computer-readable non-transitory storage medium storing a program for causing a computer to: recognize a surrounding environment of a vehicle; perform driving control based on one or both of speed control and steering control of the vehicle on the basis of a recognition result; acquire the remaining amount of energy of a terminal device of an occupant of the vehicle or the remaining amount of energy of the vehicle; and provide a notification to the occupant when traveling based on the driving control of the vehicle is predicted to be started and when the remaining amount of energy that has been acquired is less than or equal to a threshold value.

According to the above-described aspects (1) to (10), it is possible to minimize situations in which communication with a vehicle is disabled.

### BRIEF DESCRIPTION OF THE DRAWINGS

FIG. 1 is a configuration diagram of a vehicle system using a vehicle control system according to an embodiment.

FIG. 2 is a functional configuration diagram of a first controller and a second controller.

FIG. 3 is a diagram showing an example of a functional configuration of a terminal device.

FIG. 4 is a diagram schematically showing a scene in which a self-traveling parking event is executed according to the first embodiment.

FIG. 5 is a diagram showing an example of a configuration of a parking lot management device.

FIG. 6 is a diagram showing an example of an inquiry image.

FIG. 7 is a diagram showing an example of an image for notifying an occupant that self-traveling parking cannot be performed due to a shortage of fuel in the vehicle.

FIG. 8 is a flowchart showing a flow of a process to be executed by an automated driving controller according to the first embodiment.

FIG. 9 is a flowchart showing a flow of a process to be executed by an automated driving controller according to a modified example.

FIG. 10 is a diagram shown to schematically describe an extracted functional configuration that is added to the vehicle system of the first embodiment in a second embodiment.

FIG. 11 is a diagram schematically showing a scene in which a self-traveling parking event is executed according to the second embodiment.

FIG. 12 is a diagram showing an example of an image displayed on a terminal device according to the second embodiment.

FIG. 13 is a diagram showing an example of an image displayed on the terminal device when there is a charging spot in a parking lot.

FIG. 14 is a diagram showing an example of an image for notifying an occupant of a charging time period.

FIG. 15 is a diagram showing an example of an image for inquiring of an occupant about a return time.

FIG. 16 is a diagram showing an example of an image for providing a notification of the remaining amount of battery power with respect to time selected by the occupant.

FIG. 17 is a flowchart showing an example of a flow of a process to be executed by the automated driving controller according to the second embodiment.

FIG. 18 is a diagram showing an example of a hardware configuration of the automated driving controller according to the first and second embodiments.

### DESCRIPTION OF EMBODIMENTS

Hereinafter, embodiments of a vehicle control system, a vehicle control method, and a storage medium according to the present invention will be described with reference to the drawings. Hereinafter, an embodiment in which the vehicle control system is applied to an automated driving vehicle will be described as an example. In automated driving, for example, driving control is executed by automatically performing one or both of speed control and steering control of the vehicle. The driving control may be performed on the automated driving vehicle according to a manual operation of an occupant.

### First Embodiment

### [Overall Configuration]

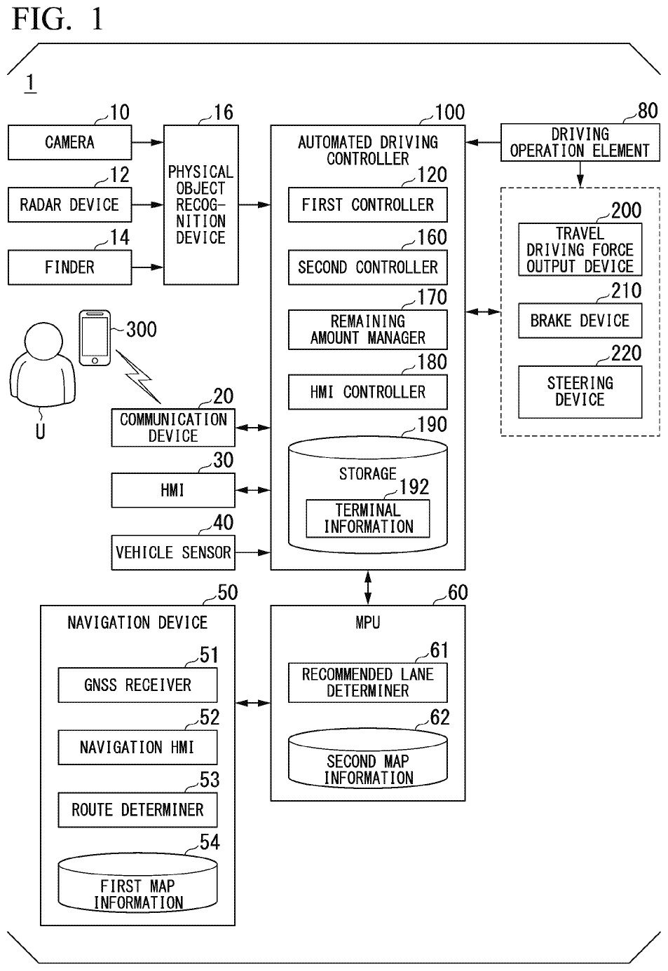

FIG. 1 is a configuration diagram of a vehicle system 1 using a vehicle control system according to a first embodiment. For example, a vehicle on which the vehicle system 1 is mounted is, for example, a two-wheeled vehicle, a three-wheeled vehicle, or a four-wheeled vehicle. A driving source of the vehicle is an internal combustion engine such as a diesel engine or a gasoline engine, an electric motor, or a combination thereof. The electric motor is operated using electric power generated from an electric power generator connected to the internal combustion engine or discharge electric power of a vehicle battery (a storage battery) such as a secondary battery or a fuel cell.

For example, the vehicle system 1 includes a camera 10, a radar device 12, a finder 14, a physical object recognition device 16, a communication device 20, a human machine interface (HMI) 30, a vehicle sensor 40, a navigation device 50, a map positioning unit (MPU) 60, a driving operation element 80, an automated driving controller 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example, a part of the configuration may be omitted, and another configuration may be further added. A combination of the communication device 20 and the automated driving controller 100 is an example of a “vehicle control system”. The automated driving controller 100 is an example of a “driving controller”. A remaining amount manager 170 is an example of an “acquirer”. The HMI 30 is an example of a “notifier”. An HMI controller 180 is an example of a “notification controller”.

For example, the camera 10 is a digital camera using a solid-state imaging element such as a charge coupled device (CCD) or a complementary metal oxide semiconductor (CMOS). The camera 10 is attached to any position on the vehicle (hereinafter, a vehicle M) on which the vehicle system 1 is mounted. When the view in front of the vehicle M is imaged, the camera 10 is attached to an upper part of a front windshield, a rear surface of a rearview mirror, or the like. For example, the camera 10 periodically and iteratively images the surroundings of the vehicle M. The camera 10 may be a stereo camera.

The radar device 12 radiates radio waves such as millimeter waves around the vehicle M and detects at least a position (a distance to and a direction) of a physical object by detecting radio waves (reflected waves) reflected by the physical object. The radar device 12 is attached to any position on the vehicle M. The radar device 12 may detect a position and speed of the physical object in a frequency modulated continuous wave (FM-CW) scheme.

The finder 14 is a light detection and ranging (LIDAR) finder. The finder 14 radiates light to the vicinity of the vehicle M and measures scattered light. The finder 14 detects a distance to an object on the basis of time from light emission to light reception. The radiated light is, for example, pulsed laser light. The finder 14 is attached to any position on the vehicle M.

The physical object recognition device 16 performs a sensor fusion process on detection results from some or all of the camera 10, the radar device 12, and the finder 14 to recognize a position, a type, a speed, and the like of a physical object. The physical object recognition device 16 outputs recognition results to the automated driving controller 100. The physical object recognition device 16 may output detection results of the camera 10, the radar device 12, and the finder 14 to the automated driving controller 100 as they are. The physical object recognition device 16 may be omitted from the vehicle system 1.

The communication device 20 communicates with the terminal device 300 used by an occupant U of the vehicle M, another vehicle present in the vicinity of the vehicle M, a parking lot management device (to be described below), or various types of server devices using, for example, a cellular network or a Wi-Fi network, Bluetooth (registered trademark), dedicated short range communication (DSRC), or the like. The terminal device 300 is, for example, a portable terminal such as a smartphone or a tablet terminal possessed by the occupant U.

The HMI 30 presents various types of information to an occupant of the vehicle M and receives an input operation of the occupant. The HMI 30 includes various types of display devices, a speaker, a buzzer, a touch panel, a switch, keys, and the like. The display device includes, for example, a meter display provided in a portion of an instrument panel facing a driver, a center display provided at the center of the instrument panel, a head up display (HUD), and the like. For example, the HUD is a device that allows the occupant to visually recognize an image by superimposing the image on a landscape. As an example, the HUD projects light including an image on a front windshield or a combiner of the vehicle M, thereby allowing the occupant to visually recognize a virtual image.

The vehicle sensor 40 includes a vehicle speed sensor configured to detect the speed of the vehicle M, an acceleration sensor configured to detect acceleration, a yaw rate sensor configured to detect an angular speed around a vertical axis, a direction sensor configured to detect a direction of the vehicle M, and the like. A result detected by the vehicle sensor 40 is output to the automated driving controller 100 or the like.

For example, the navigation device 50 includes a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the vehicle M on the basis of a signal received from a GNSS satellite. The position of the vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determiner 53 determines a route (hereinafter referred to as a route on a map) from the position of the vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by a link. The first map information 54 may include a curvature of a road, point of interest (POI) information, and the like. The route on the map is output to the MPU 60. The navigation device 50 may perform route guidance using the navigation HMI 52 on the basis of the route on the map. The navigation device 50 may be implemented, for example, according to a function of a terminal device 300 of the occupant U. The navigation device 50 may transmit a current position and a destination to a navigation server via the communication device 20 and acquire a route equivalent to the route on the map from the navigation server. The navigation device 50 outputs the determined route on the map to the MPU 60.

For example, the MPU 60 includes a recommended lane determiner 61 and stores second map information 62 in a storage device such as an HDD or a flash memory. The recommended lane determiner 61 divides the route on the map provided from the navigation device 50 into a plurality of blocks (for example, divides the route every 100 [m] with respect to a traveling direction of the vehicle), and determines a recommended lane for each block with reference to the second map information 62. The recommended lane determiner 61 determines what number lane the vehicle travels in from the left. The recommended lane determiner 61 determines the recommended lane so that the vehicle M can travel along a reasonable route for traveling to a branching destination when there is a branch point in the route on the map.

The second map information 62 is map information which has higher accuracy than the first map information 54. For example, the second map information 62 includes information about a center of a lane, information about a boundary of a lane, and the like. The second map information 62 may include road information, traffic regulations information, address information (an address/zip code), facility information, parking area information, charging spot information, telephone number information, and the like. The parking lot information includes, for example, a position and a shape of the parking lot, the number of vehicles that can be parked, the availability of automated driving, and the like. The charging spot information is, for example, position information, charging facility details, the number of devices capable of performing charging, and the like. The second map information 62 may be updated at any time when the communication device 20 communicates with another device.

For example, the driving operation element 80 includes an accelerator pedal, a brake pedal, a shift lever, a steering wheel, a steering wheel variant, a joystick, and other operation elements. A sensor configured to detect an amount of operation or the presence or absence of an operation is attached to the driving operation element 80, and a detection result thereof is output to the automated driving controller 100 or some or all of the travel driving force output device 200, the brake device 210, and the steering device 220.

The automated driving controller 100 includes, for example, a first controller 120, a second controller 160, the remaining amount manager 170, the HMI controller 180, and a storage 190. The first controller 120, the second controller 160, the remaining amount manager 170, and the HMI controller 180 are implemented, for example, by a hardware processor such as a central processing unit (CPU) executing a program (software). Some or all of these components are implemented, for example, by hardware (a circuit including circuitry) such as large scale integration (LSI), an application specific integrated circuit (ASIC), a field-programmable gate array (FPGA), or a graphics processing unit (GPU) or may be implemented by cooperation between software and hardware. The program may be pre-stored in a storage device such as an HDD or a flash memory of the automated driving controller 100 (a storage device including a non-transitory storage medium) or may be installed in the HDD or the flash memory of the automated driving controller 100 when the program is stored in a removable storage medium such as a DVD or a CD-ROM and the storage medium (the non-transitory storage medium) is mounted in a drive device.

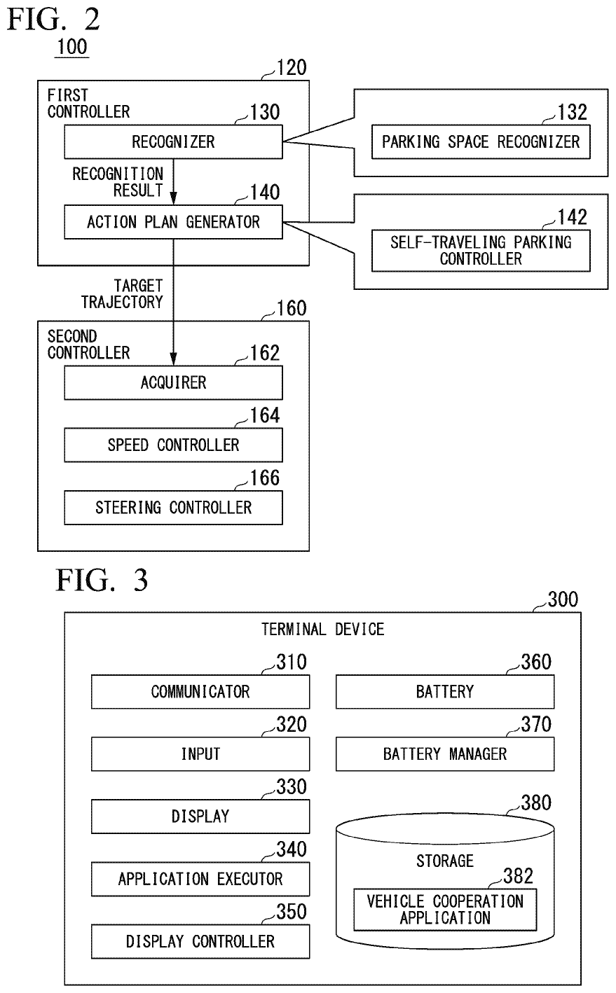

FIG. 2 is a functional configuration diagram of the first controller 120 and the second controller 160. The first controller 120 includes, for example, a recognizer 130, and an action plan generator 140. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both the recognitions. Thereby, the reliability of automated driving is secured.

The recognizer 130 recognizes a state such as a position, velocity, or acceleration of a physical object present in the vicinity of the vehicle M on the basis of information input from the camera 10, the radar device 12, and the finder 14 via the physical object recognition device 16. For example, the position of the physical object is recognized as a position on absolute coordinates with a representative point (a center of gravity, a driving shaft center, or the like) of the vehicle M as the origin and is used for control. The position of the physical object may be represented by a representative point such as a center of gravity or a corner of the physical object or may be represented by a represented region. The “state” of a physical object may include acceleration or jerk of the physical object or an “action state” (for example, whether or not a lane change is being made or intended).

For example, the recognizer 130 recognizes a lane in which the vehicle M is traveling (a travel lane). For example, the recognizer 130 recognizes the travel lane by comparing a pattern of a road dividing line (for example, an arrangement of solid lines and broken lines) obtained from the second map information 62 with a pattern of road dividing lines in the vicinity of the vehicle M recognized from an image captured by the camera 10. The recognizer 130 may recognize a travel lane by recognizing a traveling path boundary (a road boundary) including a road dividing line, a road shoulder, a curb stone, a median strip, a guardrail, or the like as well as a road dividing line. In this recognition, a position of the vehicle M acquired from the navigation device 50 or a processing result of the INS may be added. The recognizer 130 recognizes a temporary stop line, an obstacle, red traffic light, a toll gate, an entrance/exit gate of a parking area, and other road events.

When the travel lane is recognized, the recognizer 130 recognizes a position or orientation of the vehicle M with respect to the travel lane. For example, the recognizer 130 may recognize a gap of a reference point of the vehicle M from the center of the lane and an angle formed with respect to a line connecting the center of the lane in the travel direction of the vehicle M as a relative position and orientation of the vehicle M related to the travel lane. Alternatively, the recognizer 130 may recognize a position of the reference point of the vehicle M related to one side end portion (a road dividing line or a road boundary) of the travel lane or the like as a relative position of the vehicle M related to the travel lane.

The recognizer 130 includes a parking space recognizer 132 that is activated in a self-traveling parking event to be described below. Details of the function of the parking space recognizer 132 will be described below.

The action plan generator 140 generates a future target trajectory along which the vehicle M automatically travels (independently of a driver's operation) so that the vehicle M can generally travel in the recommended lane determined by the recommended lane determiner 61 and further cope with a surrounding situation of the vehicle M. For example, the target trajectory includes a speed element. For example, the target trajectory is represented by sequentially arranging points (trajectory points) at which the vehicle M is required to arrive. The trajectory point is a point where the vehicle M is required to reach for each predetermined traveling distance (for example, about several meters [m]) along a road. In addition, a target speed and target acceleration for each predetermined sampling time (for example, about several tenths of a second [sec]) are generated as parts of the target trajectory. The trajectory point may be a position at which the vehicle M is required to arrive at the sampling time for each predetermined sampling time. In this case, information about the target speed or the target acceleration is represented by an interval between the trajectory points.

The action plan generator 140 may set an automated driving event when the target trajectory is generated. The automated driving event includes a constant-speed traveling event, a low-speed following traveling event, a lane change event, a branching event, a merging event, a takeover event, a self-traveling parking event for parking the vehicle according to automated traveling (automated driving) in a valet parking or the like, and the like. For example, the automated traveling is traveling of the vehicle M according to the automated driving. The action plan generator 140 generates a target trajectory according to the activated event. For example, the action plan generator 140 includes a self-traveling parking controller 142 that is activated when the self-traveling parking event is executed. Details of the function of the self-traveling parking controller 142 will be described below.

The second controller 160 controls the travel driving force output device 200, the brake device 210, and the steering device 220 so that the vehicle M passes through the target trajectory generated by the action plan generator 140 at a scheduled time.

The second controller 160 includes, for example, an acquirer 162, a speed controller 164, and a steering controller 166. The acquirer 162 acquires information of a target trajectory (a trajectory point) generated by the action plan generator 140 and causes the acquired information to be stored in a memory (not shown). The speed controller 164 controls the travel driving force output device 200 or the brake device 210 on the basis of speed elements associated with the target trajectory stored in the memory. The steering controller 166 controls the steering device 220 in accordance with a degree of curve of a target trajectory stored in the memory. For example, processes of the speed controller 164 and the steering controller 166 are implemented by a combination of feed-forward control and feedback control. As one example, the steering controller 166 executes feed-forward control according to the curvature of the road in front of the vehicle M and feedback control based on a deviation from the target trajectory in combination.

Returning to FIG. 1, the remaining amount manager 170 acquires the remaining amount of energy of the terminal device 300 or the vehicle M. The remaining energy of energy of the terminal device 300 is, for example, the remaining amount of battery power. The remaining amount of energy of the vehicle M is, for example, the remaining amount of fuel. The fuel of the vehicle M in the first embodiment is, for example, gasoline. In the following, it is assumed that the remaining amount of battery power is used as an example of the remaining amount of energy of the terminal device 300 and the remaining amount of fuel is used as an example of the remaining amount of energy of the vehicle M. When the remaining amount of battery power of the terminal device 300 is acquired, the remaining amount manager 170 acquires information about the terminal device 300 associated with the vehicle M from the terminal information 192 stored in the storage 190. The terminal information 192 includes, for example, a terminal ID that is identification information for identifying the terminal device 300, address information for communicating with the terminal device 300, and the like. The terminal information 192 may include information about the remaining amount of battery power of the battery acquired from the terminal device 300. The terminal information 192 may include address information of a terminal device used by each of a plurality of occupants who get into the vehicle M. The remaining amount manager 170 inquires of the terminal device 300 about the remaining amount of battery power via the communication device 20 on the basis of the address information acquired from the terminal information 192 and acquires the remaining amount of battery power from the terminal device 300. The remaining amount manager 170 may acquire the remaining amount of battery power transmitted from the terminal device 300 at predetermined time intervals or at a predetermined timing. The remaining amount manager 170 may acquire a state of charge (SOC) instead of the remaining amount of battery power described above.

For example, when the remaining amount of fuel the vehicle M is acquired, the remaining amount manager 170 acquires the remaining amount of fuel of the vehicle M using a fuel sensor provided within a fuel tank (not shown) storing gasoline. For example, the fuel sensor mechanically acquires a vertical level of a float corresponding to a liquid level of gasoline within the fuel tank and detects the remaining amount of fuel on the basis of the acquired vertical level. For example, the fuel sensor may convert the vertical level of the float into a resistance value using a variable resistor (a potentiometer) and detect the remaining amount of fuel according to the vertical movement of the resistance value.

The remaining amount manager 170 provides a predetermined notification to the occupant on the basis of the remaining amount of battery power or the remaining amount of fuel that has been acquired and a vehicle situation. The details of the function of the notification of the remaining amount manager 170 will be described below.

The HMI controller 180 notifies the occupant of predetermined information by means of the HMI 30. The predetermined information is, for example, information about the remaining amount of battery power of the terminal device 300 or the remaining amount of fuel of the vehicle M. The predetermined information may include information related to traveling of the vehicle M such as information about the state of the vehicle M and information about driving control. The information about the state of the vehicle M includes, for example, a speed of the vehicle M, an engine speed, a shift position, and the like. The information about the driving control includes, for example, information about whether or not automated driving is executed, information about a degree of driving assistance based on automated driving, and the like. The predetermined information may include information that is not related to the traveling of the vehicle M, such as content (for example, a movie) stored in a storage medium such as a TV program or a DVD. The HMI controller 180 may output information received by the HMI 30 to the communication device 20, the navigation device 50, the first controller 120, and the like.

The HMI controller 180 may communicate with the terminal device 300 on the basis of the address information stored in the terminal information 192 via the communication device 20 and cause the HMI 30 to output information acquired from the terminal device 300. For example, the HMI controller 180 may perform control for causing the display device of the HMI 30 to display a registration screen for registering the terminal device 300 that communicates with the vehicle M and causing information about the terminal device (for example, address information) registered from the registration screen to be stored in the terminal information 192. The terminal device 300 that communicates with the vehicle M is, for example, a terminal device that instructs the vehicle M to enter and leave the parking area when the vehicle M automatically travels to enter and leave the parking area according to a self-traveling parking event. The above-described registration of the terminal device 300 is executed, for example, at a predetermined timing when the occupant gets into the vehicle or before the automated driving is started. The above-described registration of the terminal device 300 may be performed by an application program (a vehicle cooperation application to be described below) installed in the terminal device 300.

The HMI controller 180 may transmit information obtained by the remaining amount manager 170 to the terminal device 300 and another external device via the communication device 20.

The storage 190 is implemented by, for example, an HDD, a flash memory, an EEPROM, a read only memory (ROM), a random access memory (RAM), or the like. The storage 190 stores, for example, the terminal information 192 and other information.

For example, the travel driving force output device 200 includes an engine and an engine electronic control unit (ECU) for controlling the engine when the host vehicle M is a car using an internal combustion engine as a power source. The engine ECU adjusts a degree of throttle opening of the engine, a shift stage, or the like in accordance with information input from the second controller 160 or information input from the driving operation element 80 and outputs a travel driving force (torque) for enabling the vehicle M to travel.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the driving operation element 80 so that brake torque according to a braking operation is output to each wheel. The brake device 210 may include a mechanism configured to transfer the hydraulic pressure generated by an operation of the brake pedal included in the driving operation element 80 to the cylinder via a master cylinder as a backup. Also, the brake device 210 is not limited to the above-described configuration and may be an electronically controlled hydraulic brake device configured to control the actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor to change the direction of the steerable wheels in accordance with the information input from the second controller 160 or the information input from the driving operation element 80.

### [Terminal Device 300]

FIG. 3 is a diagram showing an example of a functional configuration of the terminal device 300. The terminal device 300 includes, for example, a communicator 310, an input 320, a display 330, an application executor 340, a display controller 350, a battery (storage battery) 360, a battery manager 370, and a storage 380. The communicator 310, the input 320, the display 330, the application executor 340, the display controller 350, and the battery manager 370 are implemented, for example, by a hardware processor such as a CPU executing a program (software). Some or all of these components are implemented, for example, by hardware (a circuit including circuitry) such as LSI, an ASIC, an FPGA, or a GPU or may be implemented by cooperation between software and hardware. The above-described program may be pre-stored in a storage device such as an HDD or a flash memory provided in the terminal device 300 (a storage device including a non-transitory storage medium) or may be installed in the storage 380 when the program is stored in a removable storage medium such as a DVD or a CD-ROM and the storage medium (a non-transitory storage medium) is mounted on a drive device.

For example, the communicator 310 communicates with the vehicle M and other external devices via a network such as a local area network (LAN), a wide area network (WAN), or the Internet.

For example, the input 320 receives the input from a user by operating various types of keys and buttons and the like. The display 330 is, for example, a liquid crystal display (LCD) or the like. The input 320 may be configured integrally with the display 330 as a touch panel.

The application executor 340 is implemented by executing a vehicle cooperation application 382 stored in the storage 380. For example, the vehicle cooperation application 382 is an application program for communicating with the vehicle M via a network and transmitting an entering or leaving instruction based on automated driving or information about the remaining amount of battery power of the battery 360 to the vehicle M. The transmission of the remaining amount of battery power is managed by the battery manager 370 and is performed at predetermined time intervals or at a timing when an inquiry about the remaining amount of battery power has been received from the vehicle M. The vehicle cooperation application 382 may perform control for acquiring information transmitted by the vehicle M and causing the display 330 to display the information. The vehicle cooperation application 382 may perform registration of the terminal device 300 and the occupant U in the vehicle M or other processing related to vehicle cooperation.

The display controller 350 controls details to be displayed on the display 330 and a display timing. For example, the display controller 350 generates an image for displaying information executed by the application executor 340 on the display 330 and causes the display 330 to display the generated image. The display controller 350 may generate a sound associated with some or all of the details to be displayed on the display 330 and output the generated sound from a speaker (not shown) of the terminal device. The display controller 350 may cause the display 330 to display an image received from the vehicle M or may cause the speaker to output a sound received from the vehicle M.

The battery 360 supplies power to each component of the terminal device 300. The battery 360 is, for example, a secondary battery such as a lithium ion battery. As the battery 360, any device that can be charged and discharged may be used. The battery 360 is charged and discharged under the control of the battery manager 370.

The battery manager 370 manages the remaining amount of battery power and charging/discharging of the battery 360. For example, the battery manager 370 measures a terminal voltage of the battery 360, and acquires the remaining amount of battery power on the basis of a magnitude of the measured terminal voltage. For example, the battery manager 370 may acquire the remaining amount of battery power by totaling an amount of electric current stored during charging using a current detection resistor and obtaining an amount of electric current output during discharging. The battery manager 370 may store, for example, a database of discharging characteristics, temperature characteristics, and the like of the battery 360 in the storage 380 or the like in advance and acquire the remaining amount on the basis of measured voltage and current values and the database. The battery manager 370 may combine some or all of the above-described acquisition methods. The battery manager 370 may acquire a state of charge (SOC) instead of the remaining amount of battery power described above.

The battery manager 370 updates the remaining amount of battery power at a predetermined timing or at predetermined time intervals. The predetermined timing is, for example, when there is an inquiry about the remaining amount of battery power of the battery 360 from the vehicle M, when it is detected that a position of the terminal device 300 or the vehicle M has arrived at a predetermined point, or the like. The predetermined point is a point where the traveling distance of the vehicle M has reached a predetermined distance from a point in time at which the last update has been performed or a point before a point where traveling based on automated driving is predicted to be executed.

The storage 380 is implemented by, for example, an HDD, a flash memory, an EEPROM, a ROM, a RAM, or the like. For example, the vehicle cooperation application 382 and other information are stored in the storage 380.

Next, driving control in traveling based on the automated driving of the vehicle M according to the first embodiment will be specifically described. Hereinafter, as an example of a scene in which driving control in traveling based on automated driving of the vehicle M is executed, a description will be given using a scene in which self-traveling parking is performed in traveling based on the automated driving in valet parking at a visiting destination facility. In the following description, it is assumed that “unmanned traveling” in which a vehicle travels in an unmanned manner is used as an example of “traveling based on automated driving” and traveling of the vehicle M based on manual driving of an occupant is referred to as “manned traveling”. The automated driving according to the present embodiment may be performed in a state in which an occupant is present within the vehicle.

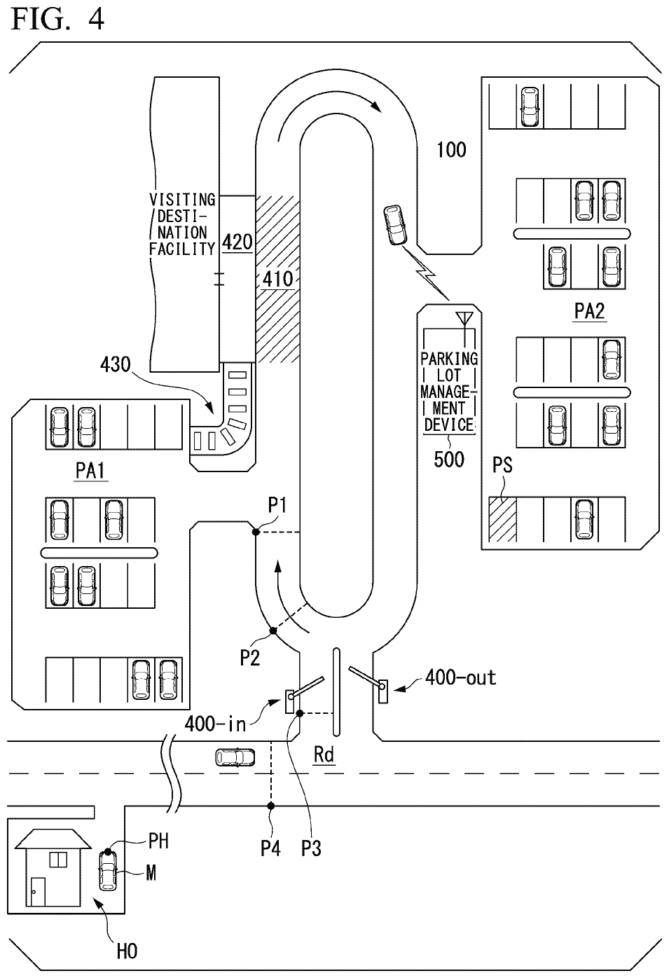

FIG. 4 is a diagram schematically showing a scene in which a self-traveling parking event is executed according to the first embodiment. In the example of FIG. 4, the parking lot (for example, valet parking) of a visiting destination facility is shown. In the parking lot, it is assumed that gates 400-in and 400-out, a stopping area 410, and a getting-into/out area 420 are provided on a route from a road Rd to the visiting destination facility. A first parking lot (an example of a first parking area) PA1 and a second parking lot (an example of a second parking area) PA2 are assumed to be provided in the parking lot. For example, it is assumed that the first parking lot PA1 is an area where the vehicle can travel according to unmanned traveling and manned traveling and is an area where the passage of the occupant of the vehicle is permitted. The occupant getting out of the parked vehicle can move between the first parking lot PA1 and the getting-into/out area 420 via a pedestrian crossing 430. The second parking lot PA2 is an area where only a vehicle of unmanned traveling can travel and is an area where the entry of persons is basically prohibited. In the example of FIG. 4, it is assumed that the first parking lot PA1 and the second parking lot PA2 include a parking lot management device 500 that manages a parking situation and transmits an availability situation and the like to the vehicle. In the example of FIG. 4, a home area HO is shown as an example of a point where the occupant U gets into the vehicle M.

Here, processing at the time of entering and leaving in a self-traveling parking event will be described first. The processing at the time of entering and leaving is executed according to, for example, the reception of an entering instruction and a leaving instruction from the terminal device 300, the elapse of a preset time, or another execution start condition which is satisfied.

### [Self-Traveling Parking Event-Time of Entering]

For example, the self-traveling parking controller 142 causes the vehicle M to be parked within a parking space in the second parking area on the basis of information acquired from the parking lot management device 500 by means of the communication device 20. In this case, the vehicle M proceeds to the stopping area 410 through the gate 400-in according to manual driving or automated driving. The stopping area 410 faces the getting-into/out area 420 connected to a visiting destination facility. The getting-into/out area 420 is provided with eaves for avoiding rain and snow.

After the occupant gets out of the vehicle M in the stopping area 410, the vehicle M performs unmanned automated driving and starts the self-traveling parking event in which the vehicle M moves to the parking space PS within the second parking lot PA2. For example, a start trigger of the self-traveling parking event may be, for example, any operation of an occupant (for example, an entering start instruction from the terminal device 300) or may be the wireless reception of a predetermined signal from the parking lot management device 500. When a self-traveling parking event starts, the self-traveling parking controller 142 controls the communication device 20 so that the communication device 20 transmits a parking request to the parking lot management device 500. The vehicle M moves from the stopping area 410 to the second parking lot PA2 in accordance with guidance of the parking lot management device 500 or while performing sensing independently.

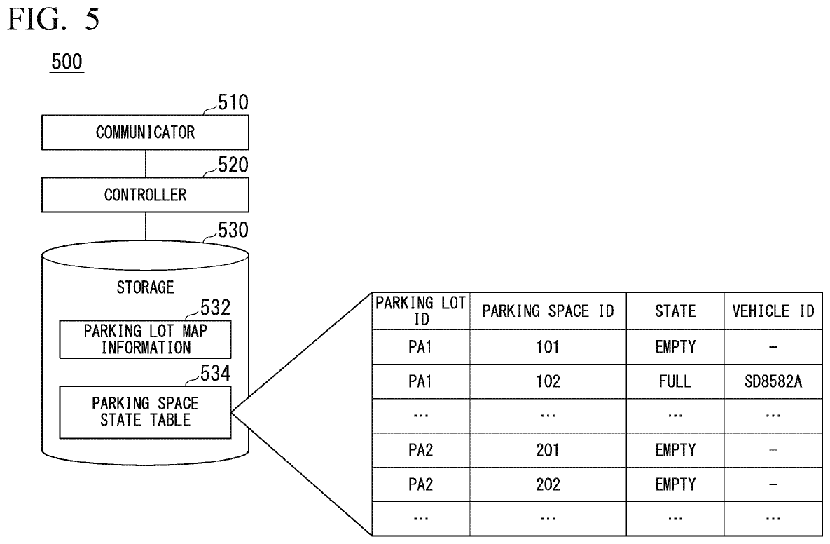

FIG. 5 is a diagram showing an example of the configuration of the parking lot management device 500. The parking lot management device 500 includes, for example, a communicator 510, a controller 520, and a storage 530. The storage 530 stores information such as parking lot map information 532 and a parking space state table 534.

The communicator 510 wirelessly communicates with the vehicle M and other vehicles. The controller 520 guides the vehicle to the parking space PS on the basis of information acquired by the communicator 510 and information stored in storage 530. The parking lot map information 532 is information geometrically indicating structures of the first parking lot PA1 and the second parking lot PA2. The parking lot map information 532 includes coordinates for each parking space PS. In the parking space state table 534, for example, a state which is an empty state or a full (parked) state and a vehicle ID which is identification information of a vehicle during parking in the case of the full state are associated with a parking lot ID that is identification information for identifying a parking lot and a parking space ID that is identification information of the parking space PS.

When the communicator 510 receives a parking request from the vehicle, the controller 520 extracts the parking space PS whose state is the empty state with reference to the parking space state table 534, acquires a position of the extracted parking space PS from the parking lot map information 532, and transmits a suitable route to the acquired position of the parking space PS to the vehicle using the communicator 510. The controller 520 instructs a specific vehicle to stop or slow down as necessary so that the vehicles do not move to the same position at the same time on the basis of positional relationships of a plurality of vehicles.

In the vehicle (hereinafter referred to as the vehicle M) receiving a route, the self-traveling parking controller 142 generates a target trajectory based on the route. When the vehicle M approaches the target parking space PS, the parking space recognizer 132 recognizes parking frame lines that divide off the parking space PS and the like, recognizes a detailed position of the parking space PS, and provides the recognized position to the self-traveling parking controller 142. The self-traveling parking controller 142 receives the provided position to correct the target trajectory and cause the vehicle M to be parked in the parking space PS.

### [Self-Traveling Parking Event-Time of Leaving]

The self-traveling parking controller 142 and the communication device 20 maintain the operation state even when the vehicle M has been parked. For example, the self-traveling parking controller 142 causes the system of the vehicle M to be activated and causes the vehicle M to move to the stopping area 410 when the communication device 20 has received a pick-up request (an example of a leaving instruction) from the terminal device 300 of the occupant U. At this time, the self-traveling parking controller 142 controls the communication device 20 so that the communication device 20 transmits a departure request to the parking lot management device 500. The controller 520 of the parking lot management device 500 instructs a specific vehicle to stop or slow down as necessary so that the vehicles do not move to the same position at the same time on the basis of positional relationships of a plurality of vehicles, as in the case of the time of entering. When the vehicle M is moved to the stopping area 410 and the occupant U is allowed to get into the vehicle M, the self-traveling parking controller 142 stops the operation and manual driving or automated driving by another functional part is started subsequently.

The self-traveling parking controller 142 may find an empty parking space by itself on the basis of the detection result of the camera 10, the radar device 12, the finder 14, or the physical object recognition device 16 independently of communication and cause the vehicle M to be parked in the found parking space without being limited to the above description.

Here, for example, when the battery 360 of the terminal device 300 runs out in a state in which the occupant U is away from the vehicle M during the execution of the self-traveling parking event described above, the vehicle cannot communicate with the vehicle M and there is a possibility that a situation in which a leaving instruction (for example, a pick-up request) cannot be transmitted may occur. When the fuel of the vehicle M runs out during the execution of the self-traveling parking event, entering and/or leaving cannot be completed and an emergency stop is performed within the second parking lot PA2 where entry of persons is prohibited.

Therefore, in the first embodiment, the HMI controller 180 provides a predetermined notification to the occupant U at a predetermined timing when the remaining amount manager 170 predicts that unmanned traveling of the vehicle M will be started and the remaining amount of fuel of the vehicle M or determines that the remaining amount of battery power of the terminal device 300 is less than or equal to a threshold value. The threshold value may be, for example, a threshold value associated with each of the remaining amount of battery power and the remaining amount of fuel or a threshold value common to the remaining amount of battery power and the remaining amount of fuel. The threshold value may be a fixed value or a variable value. The variable value is set according to a place or a region of a visiting destination, a type of vehicle, fuel efficiency, or the like. For example, when a visiting destination facility is a facility with good scenery such as a facility near a sea or a facility in which many popular characters are gathered, power consumption of the battery 360 is predicted to be increased due to the use of a camera (not shown) of the terminal device 300 or the like. In this case, the threshold value for the remaining amount of battery power is set to be larger than a reference value. When the vehicle travels uphill during unmanned traveling or travels in congested traffic, the threshold value for the remaining amount of fuel is set to be larger than a reference value. Thereby, the occupant U can be notified of a situation before the remaining amount of battery power or the remaining amount of fuel is used up.

The above-described predetermined timing is, for example, a timing at which the vehicle passes through a point before a point where unmanned traveling of the vehicle M is predicted to be started. The point before the point where the unmanned traveling of the vehicle M is predicted to be started is, for example, the stopping area 410, i.e., a point where the occupant U is predicted to get out of the vehicle. The point before the point where the unmanned traveling of the vehicle M is predicted to be started is a point before the arrival at a branch point P1 for branching to the first parking lot PA1 and the second parking lot PA2 in the example of FIG. 4. The point before the arrival at the branch point P1 may be, for example, a point P2 where the branch point P1 is estimated to be visible to the occupant U sitting in a driver's seat of the vehicle M or may be a point P3 where the vehicle M has reached the gate 400-in. The point before the arrival at the branch point P1 may be a point P4 at which a traveling distance from the branch point P1 is a predetermined distance beforehand. For example, the point P4 is a point where communication is enabled between the parking lot management device 500 and the vehicle M. By providing a notification at a point before the arrival at the branch point P1, the occupant U can ascertain in advance whether or not the remaining amount of battery power or the remaining amount of fuel is small or whether or not self-traveling parking can be performed. Thus, even when parking is switched from self-traveling parking based on unmanned traveling to parking based on manual driving or automated driving of manned traveling, the vehicle M can be smoothly moved to the first parking lot PA1.

When a notification is provided to the occupant U, the remaining amount manager 170 outputs notification information and information of an output destination to the HMI controller 180. When inquiry information for inquiring about whether or not to execute the unmanned traveling of the vehicle M has been acquired from the remaining amount manager 170, the HMI controller 180 transmits the inquiry information to the terminal device 300 designated as the output destination. The terminal device 300 receives the inquiry information transmitted by the communication device 20, generates an image corresponding to the inquiry information, and causes the display 330 to display the generated image.

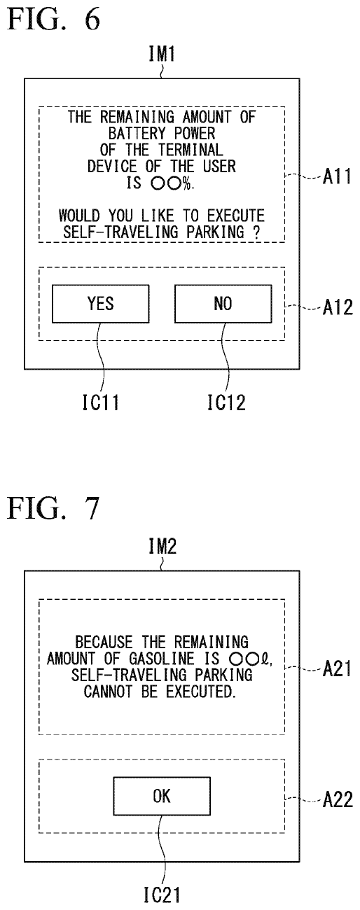

FIG. 6 is a diagram showing an example of an inquiry image IM1. The inquiry image IM1 includes a text information display area A11 and a selection item display area A12. The text information display area A11 includes, for example, information about the remaining amount of battery power of the battery 360 of the terminal device 300 and inquiry information for inquiring about whether or not to execute self-traveling parking. The selection item display area A12 includes an icon IC11 that receives an instruction for executing self-traveling parking and an icon IC12 that receives an instruction for rejecting the execution of the self-traveling parking.

For example, although the image shown in FIG. 6 is displayed on the display 330 of the terminal device 300 when the remaining amount of battery power of the terminal device 300 is less than or equal to a threshold value (for example, 10%), the icon IC11 for executing self-traveling parking will be selected when the occupant U has a replacement battery or when there is a charging facility of the battery 360 in the visiting destination facility and the occupant U is predicted to personally charge the battery 360. When there is no replacement battery or when charging is predicted to be impossible, the occupant U will select the icon IC12.

For example, the display controller 350 transmits information indicated by the selection of the icon IC11 or the icon IC12 by the occupant U to the vehicle M via the communicator 310.

When an inquiry result received from the terminal device 300 is an instruction for executing self-traveling parking, the remaining amount manager 170 outputs an instruction for executing a self-traveling parking event to the first controller 120. In the case of the instruction for rejecting the execution of the self-traveling parking, the remaining amount manager 170 does not cause the self-traveling parking event to be executed. As a result, the occupant U causes the vehicle M to be parked in the first parking lot PA1 according to manual driving or automated driving based on manned traveling.

FIG. 7 is a diagram showing an example of an image IM2 for notifying the occupant U that self-traveling parking cannot be performed due to a shortage of fuel of the vehicle M. The image IM2 includes a text information display area A21 and a selection item display area A22. In the text information display area A21, for example, the remaining amount of fuel and information indicating that the self-traveling parking cannot be executed because the remaining amount of fuel is small are displayed. In the selection item display area A22, for example, an icon IC21 for ending the display of the image IM2 is displayed. When an operation on the icon IC21 has been received, the display controller 350 regards that the notification to the occupant U in the text information display area A21 has been completed and outputs information indicating that the notification has been completed to the vehicle M.

When the information about the image IM2 has been transmitted to the terminal device 300, the remaining amount manager 170 does not cause the self-traveling parking event to be executed. As a result, the occupant U parks the vehicle M in the first parking lot PA1, or moves the vehicle M to a gas station or the like, according to manual driving or automated driving based on manned traveling.

The HMI controller 180 may cause the display device of the HMI 30 of the vehicle M to display the image IM1 and the image IM2 instead of causing the terminal device 300 to display the image IM1 and the image IM2. Thereby, even in a situation where the occupant U cannot see the terminal device 300 (for example, while the vehicle M is being manually operated), the occupant can be allowed to ascertain notification details. In this case, the HMI controller 180 acquires selection details of the icons in the selection item display areas A12 and A22 according to the operation of the occupant U on the HMI 30 and executes self-traveling parking in automated driving when the selection for permitting the self-traveling parking has been received on the basis of the acquired selection details. The HMI controller 180 may provide a notification to the occupant U by generating sounds associated with the display details of the images IM1 and IM2 and causing the generated sounds to be output.

### [Process Flow]

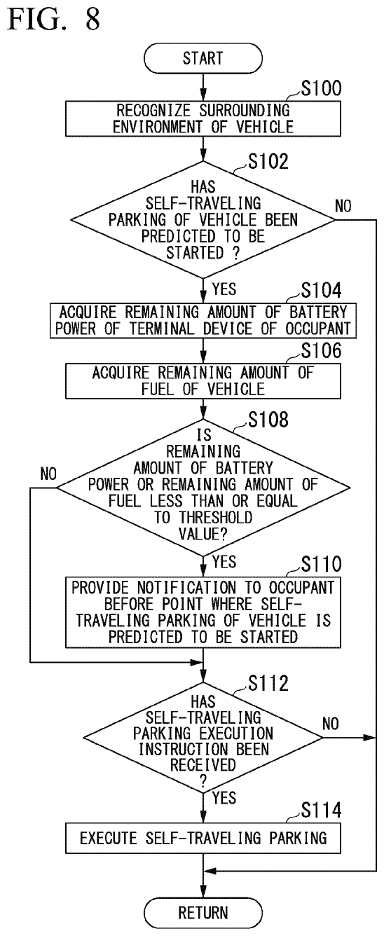

FIG. 8 is a flowchart showing a flow of a process to be executed by the automated driving controller 100 according to the first embodiment. In the process of FIG. 8, a process in a scene in which self-traveling parking (entering) is performed will be described. In the process of FIG. 8, the occupant U is assumed to be in the vehicle M. For example, the process of the present flowchart may be iteratively executed at predetermined time intervals or at a predetermined timing.

First, the recognizer 130 recognizes a surrounding environment of the vehicle M (step S100). Next, the remaining amount manager 170 determines whether or not the self-traveling parking of the vehicle M has been predicted to be started (step S102). When it is determined that the self-traveling parking of the vehicle M has been predicted to be started, the remaining amount manager 170 acquires the remaining amount of battery power of the terminal device 300 of the occupant U (step S104) and acquires the remaining amount of fuel of the vehicle M (step S106).

Next, the remaining amount manager 170 determines whether or not the remaining amount of battery power of the terminal device 300 or the remaining amount of fuel of the vehicle M is less than or equal to a threshold value (step S108). When it is determined that the remaining amount of battery power or the remaining amount of fuel is less than or equal to the threshold value, the HMI controller 180 may, for example, notify the occupant U of the remaining amount of battery power or the remaining amount of fuel before a point where the self-traveling parking of the vehicle M is predicted to be started (step S110).

After the end of step S110 or when it is determined that the remaining amount of battery power and the remaining amount of fuel exceed the threshold value in the processing of step S108, the HMI controller 180 determines whether or not an instruction for executing self-traveling parking has been received from the occupant U (step S112). When it is determined that the instruction for executing the self-traveling parking has been received, the HMI controller 180 outputs the instruction for executing the self-traveling parking to the first controller 120 and causes the self-traveling parking to be executed (step S114). Thereby, the process of the present flowchart ends. When it is determined that the start of the self-traveling parking has not been predicted in the processing of step S102 or when it is determined that the instruction for executing the self-traveling parking has not been received in the processing of the step S112, the process of the present flowchart ends.

According to the above-described first embodiment, there are provided the recognizer 130 configured to recognize a surrounding environment of the vehicle M; the driving controller (the first controller 120 and the second controller 160) configured to perform driving control based on speed control and steering control of the vehicle M on the basis of a recognition result of the recognizer 130; the remaining amount manager 170 configured to acquire the remaining amount of fuel of the vehicle M or the remaining amount of battery power of the terminal device 300 of the occupant U; and the HMI controller 180 configured to provide a notification to the occupant U when traveling based on the driving control is predicted to be started and when the remaining amount of fuel or the remaining amount of battery power acquired by the remaining amount manager 170 is less than or equal to a threshold value, so that situations in which communication with the vehicle is disabled during self-traveling parking can be minimized.

Specifically, according to the first embodiment, it is possible to minimize situations in which communication with the vehicle M is disabled after an occupant gets out of the vehicle M and the vehicle M cannot leave the second parking lot PA2 by predicting what may happen after he/she gets out of the vehicle M and warning the occupant desiring self-driving parking beforehand.

According to the first embodiment, it is possible to smoothly move the vehicle M to the first parking lot PA1 and park the vehicle M in the first parking lot PA1 even when parking has been switched from self-traveling parking to parking based on manual driving by providing a notification to the occupant U before the vehicle M passes through the first parking lot PA1 where parking based on the manual driving is possible.

### MODIFIED EXAMPLES

In the above-described first embodiment, instead of (or in addition to) a process of providing a predetermined notification before a point where traveling based on the automated driving of the vehicle M is predicted to be started, the remaining amount of battery power of the battery 360 or the remaining amount of fuel of the vehicle M may be acquired at a getting-into point (or a departure point) where the occupant U has got into the vehicle M and a notification may be provided to the occupant U when the remaining amount of battery power or the remaining amount of fuel that has been acquired is less than or equal to a threshold value.

In the example of FIG. 4, when the occupant U gets into the vehicle M parked at a parking position PH in the home area HO and the navigation device 50 sets a visiting destination facility having the second parking lot PA2 where self-traveling parking is possible as a destination, the remaining amount manager 170 acquires the remaining amount of battery power of the terminal device 300 and the remaining amount of the fuel of the vehicle M and determines whether or not the remaining amount of battery power or the remaining amount of fuel that has been acquired is less than or equal to the threshold value. Then, when the remaining amount of battery power or the remaining amount of fuel is less than or equal to the threshold value, a notification for prompting the occupant U to perform refueling, charging, or the like before reaching a destination is provided to the occupant U.

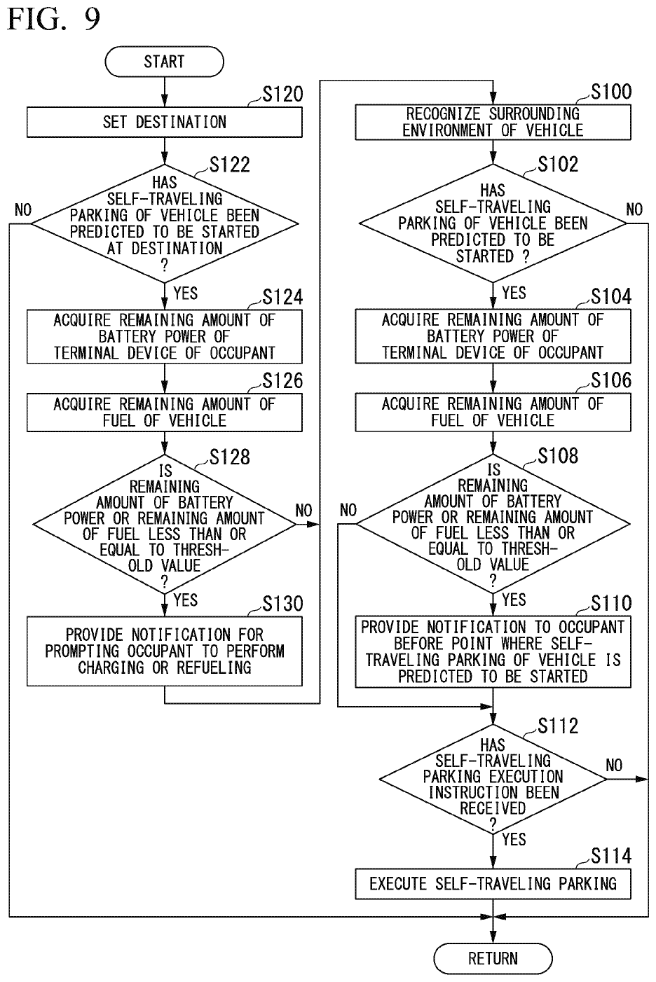

FIG. 9 is a flowchart showing a flow of a process to be executed by the automated driving controller 100 according to a modified example. The process of FIG. 9 is different from the above-described process of FIG. 8 in that the processing of steps S120 to S130 is added before the processing of step S100. In the following, the processing of steps S120 to S130 will be mainly described.

First, the navigation device 50 receives the setting of a destination from the occupant U (step S120). Next, the remaining amount manager 170 determines whether or not the self-traveling parking of the vehicle M has been predicted to be started at the destination set in the processing of step S120 (step S122). In the processing of step S122, the remaining amount manager 170 refers to the second map information 62 on the basis of position information corresponding to the destination and determines that the self-traveling parking of the vehicle M has been predicted to be started at the destination when there is an area where the self-traveling parking is possible at the destination (for example, the second parking lot PA2).

When it is determined that the self-traveling parking of the vehicle M has been predicted to be started, the remaining amount manager 170 acquires the remaining amount of battery power of the terminal device 300 of the occupant U (step S124) and acquires the remaining amount of fuel of the vehicle M (step S126). Next, the remaining amount manager 170 determines whether or not the remaining amount of battery power of the terminal device 300 or the remaining amount of fuel of the vehicle M is less than or equal to the threshold value (step S128). When it is determined that the remaining amount of battery power or the remaining amount of fuel is less than or equal to the threshold value, the HMI controller 180 provides the occupant U with a notification for prompting the occupant U to perform charging, refueling, or the like before the arrival at the destination (step S130) and subsequently performs the processing from step S100. When it is determined that the self-traveling parking of the vehicle M has not been predicted to be started in the processing of step S122, the process of the present flowchart ends.

In the above-described processing of step S130, the HMI controller 180 provides the occupant U with a notification for prompting the occupant U to perform the charging of the terminal device 300, the replacement of the battery 360, or the like when the remaining amount of battery power is less than or equal to the threshold value and provides the occupant U with a notification for prompting the occupant U to perform the refueling of gasoline when it is determined that the remaining amount of fuel is less than or equal to the threshold value. The above-described notification may be sent to the display 330 of the terminal device 300 or may be sent to the display device of the HMI 30. In the processing of step S130, the HMI controller 180 may acquire a current position of the vehicle M and route information to a destination from the navigation device 50 and notify the occupant U of a refueling point (for example, a gas station) or the like located in the vicinity of the acquired route (for example, a position where the distance from the route is less than or equal to a predetermined distance).

Thereby, the occupant U can cause the battery 360 of the terminal device 300 to be charged using a charging facility when there is a charging facility (not shown) mounted on the vehicle M, replace the battery 360, or perform refueling or the like by moving to a refueling point on the basis of a notification result.

For example, when the remaining amount of battery power of the battery 360 is also less than or equal to the threshold value before a point where the self-traveling parking of the vehicle M is predicted to be started, the remaining amount manager 170 may output an instruction for executing automated driving in which the vehicle M is temporarily stopped at a predetermined point until the remaining amount of battery power exceeds the threshold value to the first controller 120. The predetermined point is, for example, an empty space or a road shoulder before a point where the self-traveling parking of the vehicle M is predicted to be started, the first parking lot PA1, or the like.

According to the above-described modified example, the occupant can be allowed to ascertain a situation predicted at the destination in an early stage. Therefore, the occupant U can leisurely perform charging or replacement of the battery 360, refueling, or the like. Because it is possible to minimize situations in which communication between the vehicle M and the terminal device 300 is disabled during self-traveling parking, appropriate automated driving in self-traveling parking can be implemented.

### Second Embodiment

Next, a second embodiment will be described. The second embodiment shows an example in which the vehicle control system is applied to an electric vehicle using an electric motor as a power source. In the following description, functional components similar to those of the first embodiment are denoted by the same reference signs and detailed description thereof will be omitted.

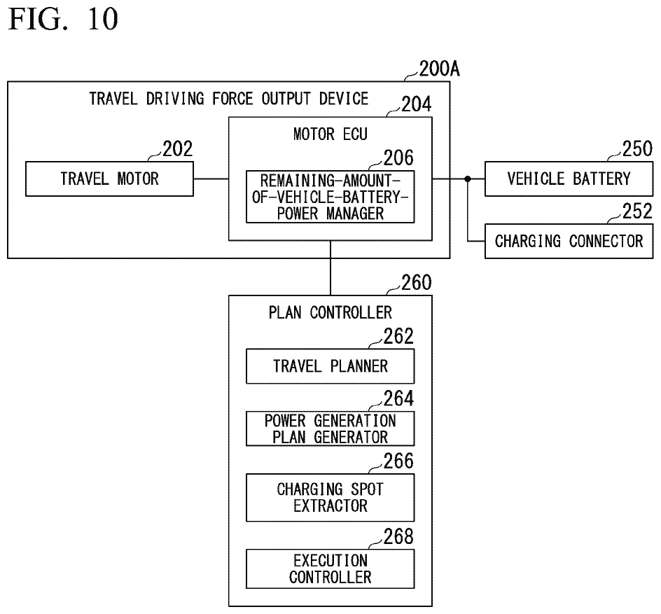

FIG. 10 is a diagram shown to schematically describe an extracted functional configuration that is added to the vehicle system 1 of the first embodiment in the second embodiment. In the example of FIG. 10, a travel driving force output device 200A is provided instead of the travel driving force output device 200 in the configuration of the vehicle system 1 shown in FIG. 1 and a vehicle battery (a storage battery) 250, a charging connector 252, a motor ECU 204, and a plan controller 260 are provided in addition to the configuration of the vehicle system 1.

The travel driving force output device 200A includes, for example, a travel motor 202 and a motor ECU 204. The motor ECU 204 controls the driving of the travel motor 202 using electric power supplied from the vehicle battery 250. The motor ECU 204 adjusts a duty ratio of a PWM signal applied to the travel motor 202 in accordance with information input from the second controller 160 or information input from the driving operation element 80 and the travel motor 202 outputs a travel driving force (torque) for enabling the vehicle M to travel. For example, the motor ECU 204 may perform charging by returning electricity generated by forcibly turning the travel motor 202 to the vehicle battery 250 when the wheels rotate after an accelerator is released.

The motor ECU 204 includes, for example, a remaining-amount-of-vehicle-battery-power manager 206. The remaining-amount-of-vehicle-battery-power manager 206 ascertains a state of the vehicle battery 250 and monitors the input and output of electric power to and from the vehicle battery 250. For example, the remaining-amount-of-vehicle-battery-power manager 206 acquires the remaining amount of battery power of the vehicle battery 250 (an example of the remaining amount of energy). For example, the remaining-amount-of-vehicle-battery-power manager 206 measures a terminal voltage of the vehicle battery 250 and acquires the remaining amount of battery power on the basis of a magnitude of the measured terminal voltage. For example, the remaining-amount-of-vehicle-battery-power manager 206 may acquire the remaining amount of battery power by integrating an amount of electric current stored during charging using a current detection resistor and obtaining an amount of electric current output during discharging. For example, the remaining-amount-of-vehicle-battery-power manager 206 may store a database of discharging characteristics and temperature characteristics of the vehicle battery 250 in a storage or the like in advance and acquire the remaining amount on the basis of a voltage value and a current value that have been measured and the database. The remaining-amount-of-vehicle-battery-power manager 206 may combine some or all of the above-described acquisition methods. The remaining-amount-of-vehicle-battery-power manager 206 may acquire a state of charge (SOC) instead of the above-described remaining amount of battery power. The remaining-amount-of-vehicle-battery-power manager 206 may perform cooling management of the vehicle battery 250, monitoring of a high-voltage safety circuit (not shown), and the like.

The vehicle battery 250 supplies electric power for driving the traveling of the vehicle M. The vehicle battery 250 is, for example, a secondary battery such as a lithium ion battery. Any device may be used as the vehicle battery 250 as long as charging and discharging are possible. The vehicle battery 250 is charged and discharged under the control of the motor ECU 204.

The charging connector 252 is a detachably configured connector connected to a charging plug of the charging facility to acquire electric power supplied from the charging facility installed at the charging spot. For example, the vehicle battery 250 is charged in a state in which the charging connector 252 and the charging plug are connected. The vehicle M may include an electric power receiver (not shown) configured to wirelessly receive electric power instead of the charging connector 252. In this case, the vehicle battery 250 is charged wirelessly by stopping the vehicle M at a position where the electric power receiver can receive electric power in a non-contact manner from an electric power transmitter provided at the charging spot.

The plan controller 260 includes, for example, a travel planner 262, a power generation plan generator 264, a charging spot extractor 266, and an execution controller 268. These components are implemented, for example, by a hardware processor such as a CPU executing a program (software). Some or all of these components may be implemented by hardware (a circuit including circuitry) such as LSI, an ASIC, an FPGA, and a GPU or may be implemented by cooperation between software and hardware.

The travel planner 262 acquires a travel plan of the vehicle M to the destination. For example, the travel planner 262 acquires information about a route on the map or route guidance generated on the basis of a destination set by the occupant U operating the navigation device 50 as a travel plan. The travel planner 262 may regenerate the travel plan on the basis of, for example, information of a change in a road of a traveling schedule, a traffic congestion level, a speed limit, and the like. This information may be information acquired by a server device that can communicate with the communication device 20 mounted on the vehicle M or may be information generated on the basis of a traveling situation of the vehicle M or the like.

The power generation plan generator 264 generates a power generation plan obtained by defining a power generation pattern of a power generator on a travel route planned in the travel plan acquired by the travel planner 262. For example, the power generation plan is a plan for charging the vehicle battery 250. The power generation plan may be a plan for maintaining the remaining amount of battery power or more required to pass through a predetermined section of the travel route. The predetermined section may be a section set on the basis of a traveling distance or may be a section based on a traveling situation such as a congested section or a tunnel section.

The charging spot extractor 266 extracts a charging spot near the travel route to the destination set by the occupant U, a charging spot installed in a parking lot at the destination, and the like. The vicinity of the travel route is, for example, within a predetermined distance from the travel route. For example, the charging spot extractor 266 refers to the second map information 62 and extracts the position of the charging spot within a predetermined distance (for example, within 1 [km]) from the travel route and the number of vehicles that can be charged simultaneously.

The charging spot extractor 266 may access a server device that manages a usage situation of each charging spot using the communication device 20 and acquire information about a current usage situation of the extracted charging spot or a usage situation at a scheduled arrival time. The charging spot extractor 266 may directly access the extracted charging spot using the communication device 20 to acquire the usage situation.

The execution controller 268 executes the power generation plan on the basis of the occupant operation received from the HMI 30 or the like. When the charging connector 252 has been connected to the charging facility of the charging spot or when the vehicle has arrived at a facility capable of wirelessly charging the battery of the vehicle, the execution controller 268 executes charging of the vehicle battery 250 on the basis of a charging execution instruction from the occupant U. For example, the execution controller 268 may acquire the remaining distance from the current position of the vehicle M to the destination or acquire the remaining amount of battery power of the vehicle battery 250 at a predetermined timing for each predetermined period of time, each predetermined traveling distance, or the like and may output the acquired remaining amount to the display device of the HMI 30.

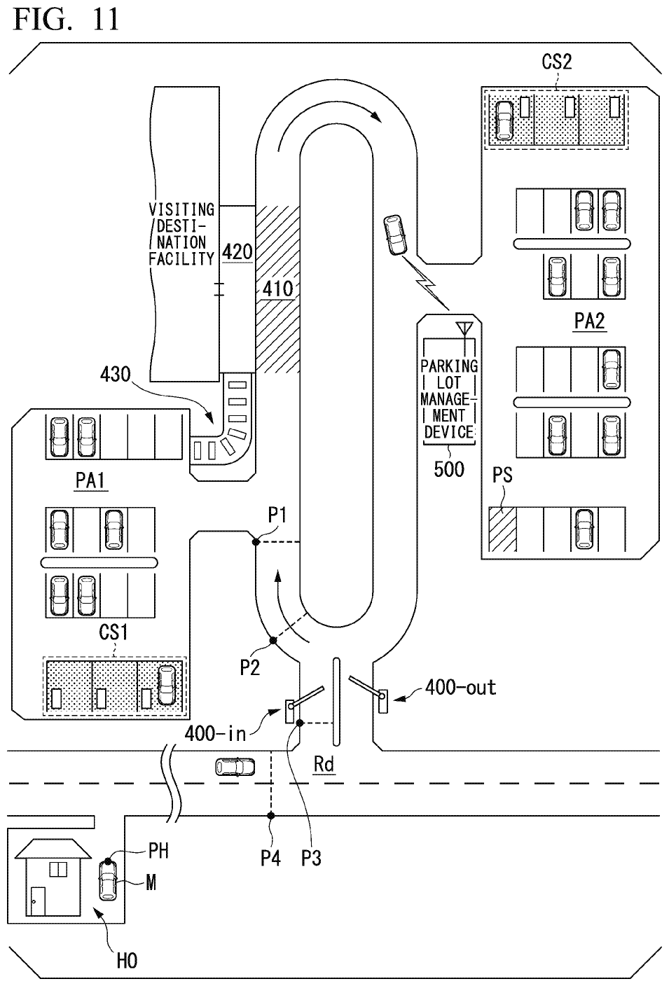

FIG. 11 is a diagram schematically showing a scene in which a self-traveling parking event is executed according to the second embodiment. The example of FIG. 11 is different from the above-described example of FIG. 4 in that charging spots CS1 and CS2 are provided in the first parking lot PA1 and the second parking lot PA2. The charging spots CS1 and CS2 include a facility capable of wirelessly charging the battery of the vehicle.

In the second embodiment, the remaining amount manager 170 acquires the remaining amount of battery power of the vehicle battery 250 from the remaining-amount-of-vehicle-battery-power manager 206. The HMI controller 180 provides a notification to the occupant U before a point where traveling based on the automated driving of the vehicle M is predicted to be started when traveling based on the automated driving (for example, unmanned traveling) of the vehicle M is predicted to be started by the automated driving controller 100 and when the remaining amount of battery power of the vehicle battery 250 is less than or equal to the threshold value.

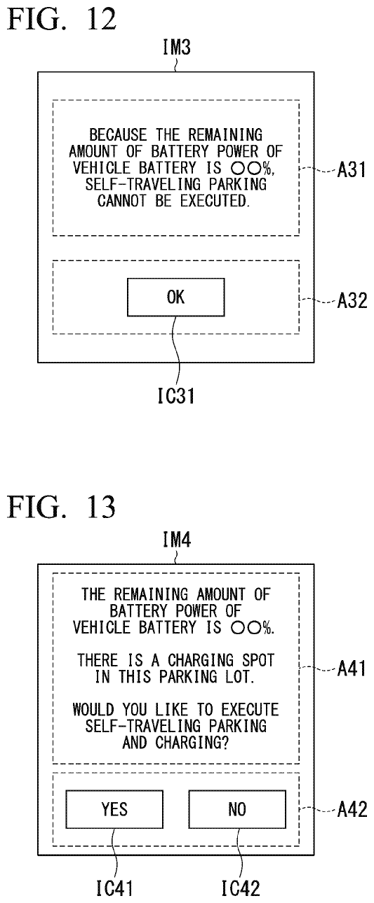

FIG. 12 is a diagram showing an example of an image IM3 displayed on the terminal device 300 according to the second embodiment. The image IM3 includes a text information display area A31 and a selection item display area A32. In the text information display area A31, for example, the remaining amount of battery power of the battery of the vehicle M and information indicating that self-traveling parking (a self-traveling parking event based on automated driving) cannot be executed are displayed. In the selection item display area A32, for example, an icon IC31 for ending the display of the image IM3 is displayed.

When information about the image IM3 is transmitted to the terminal device 300, the remaining amount manager 170 does not cause the self-traveling parking event to be executed. As a result, the occupant U moves the vehicle M to the first parking lot PA1 according to manual driving or automated driving based on manned traveling.

The HMI controller 180 may acquire information about the charging spot from the plan controller 260 at a timing when the above-described notification is provided to the occupant U and may provide a notification of information for inquiring of the occupant U about whether or not to charge the battery when the charging spots CS1 and CS2 available in the first parking lot PA1 or the second parking lot PA2 are present.

FIG. 13 is a diagram showing an example of an image IM4 displayed on the terminal device 300 when there is a charging spot in the parking lot. The image IM4 includes a text information display area A41 and a selection item display area A42. In the text information display area A41, for example, the remaining amount of battery power of the battery of the vehicle M, the presence of a charging spot, and information for inquiring about whether to execute self-traveling parking and charging are displayed. The selection item display area A42 includes, for example, an icon IC41 for issuing an instruction for executing self-traveling parking and charging and an icon IC42 for issuing an instruction for rejecting the execution of self-traveling parking and charging.

For example, the display controller 350 transmits information designated by the selection of the icon IC41 or the icon IC42 by the occupant U to the vehicle M via the communicator 310.

When an inquiry result received from the terminal device 300 indicates that self-traveling parking and charging are executed, the remaining amount manager 170 outputs an instruction for executing a self-traveling parking event to the first controller 120 and outputs a charging execution instruction after parking to the plan controller 260. Thereby, after the vehicle M allows the occupant U to get out thereof in the stopping area 410 shown in FIG. 11, the vehicle M acquires information about an empty space of the charging spot CS2 of the second parking lot PA2 from the parking lot management device 500 and is parked according to traveling based on the automated driving in the acquired empty space. After the vehicle M is parked at the charging spot CS2, the vehicle battery 250 is charged.

When the inquiry result received from the terminal device 300 is an instruction for rejecting the execution of self-traveling parking and charging, the remaining amount manager 170 does not output a self-traveling parking event execution instruction or a charging execution instruction. As a result, the occupant U causes the vehicle M to be parked at the charging spot in the first parking lot PA1 according to manual driving or automated driving based on manned traveling and charges the vehicle battery 250.

When the occupant U has selected the icon IC41 for issuing an instruction for executing self-traveling parking and charging with respect to the image IM4 shown in FIG. 13, the remaining amount manager 170 may derive a period of time until the battery is charged with electric power required for self-traveling leaving or until the battery is fully charged on the basis of the current remaining amount of battery power of the vehicle battery 250 and notify the occupant U of information about the derived charging time period.

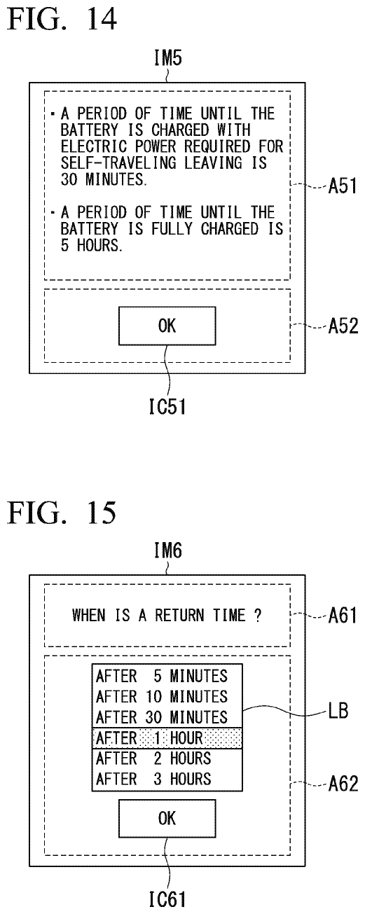

FIG. 14 is a diagram showing an example of an image IM5 for notifying the occupant U of the charging time period. The image IM5 includes a text information display area A51 and a selection item display area A52. In the text information display area A51, for example, information about one or both of a period of time until the vehicle battery 250 is charged with electric power required for the vehicle M to execute self-traveling leaving from the parking space to the stopping area 410 and a period of time until the vehicle battery 250 is fully charged is displayed. In the example of FIG. 14, “A period of time until the battery is charged with electric power required for self-traveling leaving is 30 minutes.” and “A period of time until the battery is fully charged is 5 hours.” are displayed in the text information display area A51. In the selection item display area A52, for example, an icon IC51 for ending the display of the image IM5 is displayed. As described above, the charging time period until the self-traveling leaving by the vehicle M is enabled is displayed in the text information display area A51, so that the time when the self-traveling leaving is possible can be clearly communicated to the occupant U and the occupant U can use time efficiently.

When the occupant U has selected the icon IC41 for issuing an instruction for executing self-traveling parking and charging with respect to the image IM4 shown in FIG. 13, the remaining amount manager 170 may inquire of the occupant U about the time when he/she returns from a visiting destination facility (or the time when the occupant U issues a leaving instruction for the vehicle M).

FIG. 15 is a diagram showing an example of an image IM6 for inquiring of the occupant about a return time. The image IM6 includes, for example, a text information display area A61 and a selection item display area A62. In the text information display area A61, for example, information for inquiring of the occupant U about when is a return time is displayed. In the selection item display area A62, for example, a list box LB for selecting any one of a plurality of time options and an icon IC61 indicating that the time selected in the list box LB is good may be displayed. In the selection item display area A62, the time may be selected using a combo box, a radio button, or the like instead of the list box LB or the time may be input using a text box to which the time (numerical value) can be directly input.

The occupant U selects one of the options included in the list box LB displayed on the display 330. In the example of FIG. 15, an example in which “after 1 hour” is selected from among options of “after 5 minutes”, “after 10 minutes”, “after 30 minutes”, “after 1 hour”, “after 2 hours”, and “after 3 hours” displayed in the list box of the text information display area A61 is shown. In this manner, after the time is selected, the icon IC61 of an OK button is pressed, so that the terminal device 300 outputs information about the time selected by the occupant U to the vehicle M. The remaining amount manager 170 estimates the remaining amount of battery power when the selected time has elapsed on the basis of the time selected by the occupant U and the current remaining amount of battery power of the vehicle battery 250 and provides a notification to the occupant U by causing the display 330 of the terminal device 300 to display the estimated remaining amount of battery power.

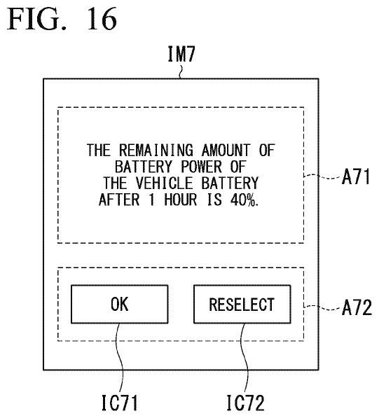

FIG. 16 is a diagram showing an example of an image IM7 for providing a notification of the remaining amount of battery power with respect to the time selected by the occupant U. The image IM7 includes, for example, a text information display area A71 and a selection item display area A72. In the text information display area A71, for example, information about the remaining amount of battery power of the vehicle battery 250 based on charging for the time (for example, after 1 hour) selected by the occupant U is displayed. In the text information display area A71, for example, an icon IC71 for ending the display of the image IM7 and an icon IC72 for transitioning to a screen (for example, the image IM6) for reselecting the return time are displayed. When the occupant U has selected the icon IC72, the HMI controller 180 causes the display 330 of the terminal device 300 to display the image IM6 of FIG. 13. Thereby, the occupant U can reselect the return time and acquire the remaining amount of battery power estimated at the selected time.

The HMI controller 180 may cause the display device of the HMI 30 to output the above-described images IM3 to IM7 or may provide a notification to the occupant U by generating sounds corresponding to display details of the images IM3 to IM7 and causing the generated sounds to be output.

### [Process Flow]

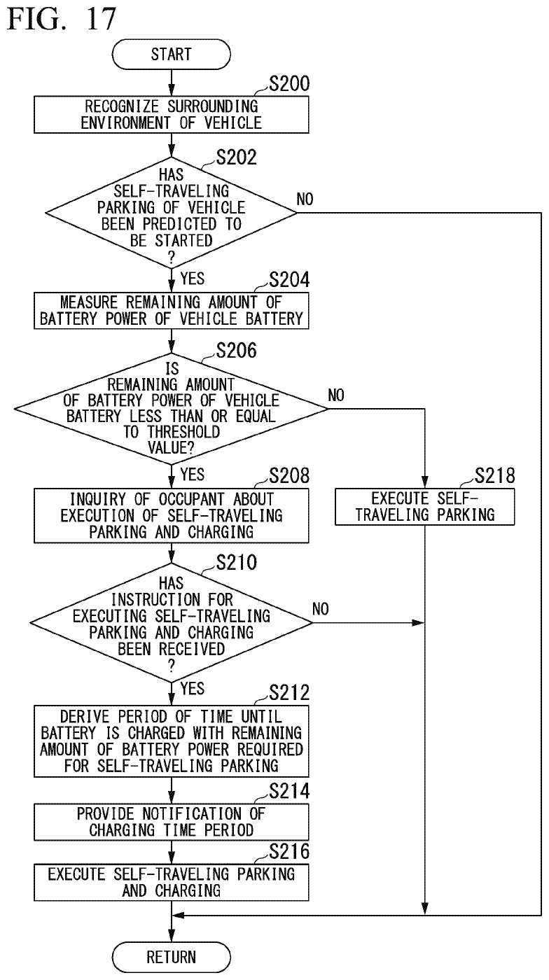

FIG. 17 is a flowchart showing an example of a flow of a process to be executed by the automated driving controller 100 according to the second embodiment. In the process of FIG. 17, a process in a scene where self-traveling parking (entering) is performed as an example of traveling based on automated driving will be described. In the process of FIG. 17, the occupant U is assumed to be in the vehicle M. For example, the process of the present flowchart may be iteratively executed at predetermined time intervals or at a predetermined timing.

First, the recognizer 130 recognizes a surrounding environment of the vehicle M (step S200). Next, the remaining amount manager 170 determines whether or not self-traveling parking of the vehicle M has been predicted to be started (step S202). When it is determined that the self-traveling parking of the vehicle M has been predicted to be started, the remaining amount manager 170 acquires the remaining amount of battery power of the vehicle battery 250 from the remaining-amount-of-vehicle-battery-power manager 206 (step S204) and determines whether or not the acquired remaining amount of battery power of the vehicle battery 250 is less than or equal to a threshold value (step S206).

When it is determined that the remaining amount of battery power is less than or equal to the threshold value, the HMI controller 180 inquires of the occupant about the execution of the self-traveling parking and the charging of the vehicle battery 250 during parking (step S208). Next, the HMI controller 180 determines whether or not an instruction for executing the self-traveling parking and the charging has been received as a response to the inquiry (step S210).

When it is determined that the instruction for executing the self-traveling parking and the charging has been received, the remaining amount manager 170 derives a period of time until the vehicle battery 250 is charged with the remaining amount of battery power required for the self-traveling parking (a charging time period) (step S212). In the processing of step S212, the remaining amount manager 170 may derive a period of time in which the vehicle battery 250 is fully charged instead of (or in addition to) the period of time described above. The remaining amount manager 170 may cause the remaining-amount-of-vehicle-battery-power manager 206 to execute the processing of step S212.

Next, the HMI controller 180 notifies the occupant U of the charging time period derived in the processing of step S212 (step S214). Next, the vehicle M executes the self-traveling parking and the charging (step S216). Thereby, the process of the present flowchart ends.

When it is determined that the remaining amount of battery power of the vehicle M exceeds the threshold value in the processing of step S206, the remaining amount manager 170 executes the self-traveling parking without charging the vehicle battery 250 (step S218) and ends the process of the present flowchart. When it is determined that the self-traveling parking of the vehicle M has not been predicted to be started in the processing of step S202 or when it is determined that the instruction for executing the self-traveling parking and the charging has not been received in the processing of step S210, the process of the present flowchart ends.

According to the above-described second embodiment, in addition to achieving effects similar to those of the above-described first embodiment, it is possible to minimize situations in which communication with the terminal device 300 is disabled during traveling based on automated driving and more appropriately perform automated driving in traveling based on the automated driving by also providing a notification of information about charging of the vehicle battery when the vehicle is an electric vehicle.

In the second embodiment, in a state in which the vehicle M is parked in the second parking lot PA2, the remaining amount manager 170 may acquire the remaining amount of battery power of the vehicle battery 250 at predetermined time intervals and transmit the acquired remaining amount of battery power to the terminal device 300 to notify the occupant of the acquired remaining amount of battery power.

When the remaining amount of battery power of the vehicle battery 250 is less than or equal to the threshold value, the remaining amount manager 170 may make an inquiry about whether or not to charge the vehicle M at the charging spot CS2 and cause control for executing charging by moving the vehicle M to the charging spot CS2 to be executed when a charging instruction has been received.

When the remaining amount of battery power of the vehicle battery 250 is less than or equal to the threshold value, the remaining amount manager 170 may output an instruction for moving the vehicle from the second parking lot PA2 to the first parking lot PA1 according to automated driving to the first controller 120 and notify the occupant of information indicating that the vehicle has been moved to the first parking lot PAL

The HMI controller 180 may monitor a situation of communication with the terminal device 300 and output an instruction for moving the vehicle from the second parking lot PA2 to the first parking lot PA1 according to automated driving to the first controller 120 when a situation in which communication with the terminal device 300 deteriorates or is disabled has continued during a predetermined period of time. It is possible to minimize situations in which communication with the vehicle M parked in an area where the entry of the occupant U is prohibited (the second parking lot PA2) is disabled and situations in which the occupant U cannot move to a position where the vehicle M is located.

Each of the first and second embodiments described above may be combined with some or all of the other embodiments. For example, when the travel driving force output device 200 includes the engine and the travel motor 202, both the engine ECU and the motor ECU control the travel driving force in cooperation with each other in accordance with information input from the second controller 160 or information input from the driving operation element 80.

Although an example in which the first parking lot PA1 is set as an area where a vehicle of unmanned traveling and manned traveling can travel and the second parking lot PA2 is set as an area where traveling is enabled according to unmanned traveling has been described in the above-described embodiment, the present invention is not limited thereto. For example, the first parking lot PA1 may be set as an area where parking can be performed according to traveling based on manual driving of the occupant and the second parking lot PA2 may be set as an area where parking can be performed according to traveling for performing driving control based on speed control and steering control of the vehicle M independently of the operation of the occupant. In this case, for example, the second parking lot PA2 includes an area where entry of a person into a part or all of the parking lot is prohibited or an area where there is a risk of entry of a person (for example, an area where there is a high possibility that a person will obstruct the movement of another vehicle within the parking lot when he/she enters the area).

### [Hardware Configuration]

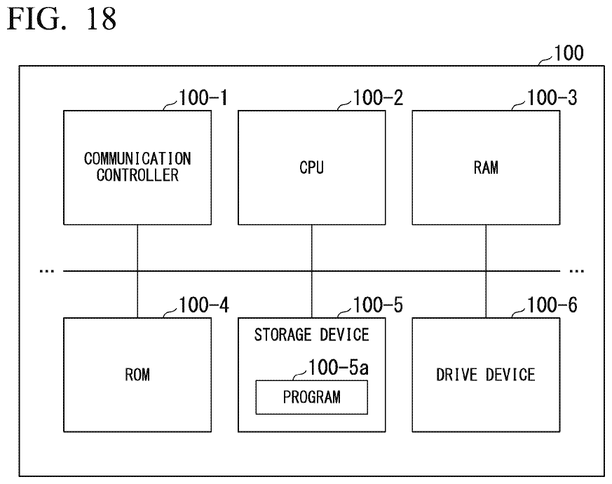

FIG. 18 is a diagram showing an example of a hardware configuration of the automated driving controller 100 of the first and second embodiments. As shown in FIG. 18, the automated driving controller 100 has a configuration in which a communication controller 100-1, a CPU 100-2, a random access memory (RAM) 100-3 used as a working memory, a read only memory (ROM) 100-4 storing a boot program and the like, a storage device 100-5 such as a flash memory or a hard disk drive (HDD), a drive device 100-6, and the like are mutually connected by an internal bus or a dedicated communication line. The communication controller 100-1 communicates with components other than the automated driving controller 100. A program 100-5a executed by the CPU 100-2 is stored in the storage device 100-5. A portable storage medium such as an optical disk (for example, a computer-readable non-transitory storage medium) is attached to the drive device 100-6. The storage device 100-5 stores the program 100-5a to be executed by the CPU 100-2. This program is loaded to the RAM 100-3 by a direct memory access (DMA) controller (not shown) or the like and executed by the CPU 100-2. The program 100-5a to be referred to by the CPU 100-2 may be stored in the portable storage medium attached to the drive device 100-6 or may be downloaded from another device via a network. Thereby, some or all of the first controller 120, the second controller 160, the remaining amount manager 170, and the HMI controller 180 are implemented.

The embodiment described above can be represented as follows.

A vehicle control system including:

a storage device configured to store a program; and

a hardware processor,

wherein the hardware processor executes the program stored in the storage device to:

recognize a surrounding environment of a vehicle;

perform driving control based on one or both of speed control and steering control of the vehicle on the basis of a recognition result;

acquire the remaining amount of energy of a terminal device of an occupant of the vehicle or the remaining amount of energy of the vehicle; and

provide a notification to the occupant when traveling based on the driving control of the vehicle is predicted to be started and when the remaining amount of energy that has been acquired is less than or equal to a threshold value.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control system comprising:
a recognizer configured to recognize a surrounding environment of a vehicle;
a driving controller configured to perform driving control based on one or both of speed control and steering control of the vehicle on the basis of a recognition result of the recognizer;
an acquirer configured to acquire the remaining amount of energy of a terminal device of an occupant of the vehicle or the remaining amount of energy of the vehicle; and
a notification controller configured to provide a notification to the occupant when traveling based on the driving control is predicted to be started by the driving controller and when the remaining amount of energy acquired by the acquirer is less than or equal to a threshold value.

2. The vehicle control system according to claim 1, wherein the notification controller provides the notification to the occupant before a point where the traveling based on the driving control is predicted to be started by the driving controller when the traveling based on the driving control is predicted to be started by the driving controller and when the remaining amount of energy is less than or equal to the threshold value.

3. The vehicle control system according to claim 1,
wherein the recognizer recognizes a first parking area where traveling based on the driving control and traveling based on manual driving of the occupant of the vehicle are possible and a second parking area where traveling based on the driving control is possible, and
wherein the notification controller provides a notification of the remaining amount of energy to the occupant before the vehicle arrives at the first parking area and the second parking area recognized by the recognizer.

4. The vehicle control system according to claim 1, wherein the notification controller notifies the occupant of information for inquiring about whether or not to execute traveling based on the driving control before a point where the traveling based on the driving control is predicted to be started.

5. The vehicle control system according to claim 1, further comprising a storage battery configured to supply electric power for travel driving of the vehicle,
wherein the acquirer acquires the remaining amount of energy of the storage battery, and
wherein the notification controller provides the notification to the occupant when the traveling based on the driving control is predicted to be started by the driving controller and when the remaining amount of energy of the storage battery acquired by the acquirer is less than or equal to the threshold value.

6. The vehicle control system according to claim 5, wherein the notification controller notifies the occupant of information for inquiring of the occupant about whether or not to charge the storage battery when the remaining amount of energy of the storage battery is less than or equal to the threshold value.

7. The vehicle control system according to claim 6, wherein the notification controller notifies the occupant of a charging time period of the storage battery when an instruction for charging the storage battery has been received from the occupant.

8. The vehicle control system according to claim 7, wherein the notification controller notifies the occupant of the remaining amount of energy of the storage battery estimated to be charged until return time when the return time for the vehicle of the occupant has been received.

9. A vehicle control method comprising:
recognizing, by a computer, a surrounding environment of a vehicle;
performing, by the computer, driving control based on one or both of speed control and steering control of the vehicle on the basis of a recognition result;
acquiring, by the computer, the remaining amount of energy of a terminal device of an occupant of the vehicle or the remaining amount of energy of the vehicle; and
providing, by the computer, a notification to the occupant when traveling based on the driving control of the vehicle is predicted to be started and when the remaining amount of energy that has been acquired is less than or equal to a threshold value.

10. A computer-readable non-transitory storage medium storing a program for causing a computer to:
recognize a surrounding environment of a vehicle;
perform driving control based on one or both of speed control and steering control of the vehicle on the basis of a recognition result;
acquire the remaining amount of energy of a terminal device of an occupant of the vehicle or the remaining amount of energy of the vehicle; and
provide a notification to the occupant when traveling based on the driving control of the vehicle is predicted to be started and when the remaining amount of energy that has been acquired is less than or equal to a threshold value.
